(19) United States
(12) Patent Application Publication
(10) Pub. No.: US 2025/0323737 A1
(43) Pub. Date: Oct. 16, 2025

(54) SPATIO-TEMPORAL BEAM PREDICTION

(71) Applicant: QUALCOMM Incorporated, San Diego, CA (US)

(72) Inventors: Akash Sandeep DOSHI, San Diego, CA (US); June NAMGOONG, San Diego, CA (US); Philip Aaron SISK, San Diego, CA (US); Taesang YOO, San Diego, CA (US); Arumugam CHENDAMARAI KANNAN, San Diego, CA (US); Tao LUO, San Diego, CA (US)

(21) Appl. No.: 18/972,262

(22) Filed: Dec. 6, 2024

Related U.S. Application Data
(60) Provisional application No. 63/634,808, filed on Apr. 16, 2024.

(51) Int. Cl. H04B 17/318; H04B 7/06

(52) U.S. Cl. CPC H04B 17/328; H04B 7/06952

(57) ABSTRACT

Method and apparatus for beam prediction based on beam pair link measurements. The apparatus receives an indication to perform a beam prediction procedure. The apparatus receives a beam embedding table utilized to perform the beam prediction procedure. The apparatus measures an RSRP for a plurality of BPLs to generate a set of input vectors for the beam prediction procedure, wherein the set of input vectors is generated based at least on the beam embedding table and past RSRP measurements. The apparatus predicts at least one future RSRP measurement of the plurality of BPLs based at least on the set of input vectors and beam embedding of the plurality of BPLs.

### CROSS REFERENCE TO RELATED APPLICATION(S)

This application claims the benefit of and priority to U.S. Provisional Application Ser. No. 63/634,808, entitled “SPATIO-TEMPORAL BEAM PREDICTION” and filed on Apr. 16, 2024, which is expressly incorporated by reference herein in its entirety.

### TECHNICAL FIELD

The present disclosure relates generally to communication systems, and more particularly, to a configuration for beam prediction based on link measurements.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a user equipment (UE). The device may be a processor and/or a modem at a UE or the UE itself. The apparatus receives an indication to perform a beam prediction procedure. The apparatus receives a beam embedding table utilized to perform the beam prediction procedure. The apparatus measures a reference signal received power (RSRP) for a plurality of beam pair links (BPLs) to generate a set of input vectors for the beam prediction procedure, wherein the set of input vectors is generated based at least on the beam embedding table and past RSRP measurements. The apparatus predicts at least one future RSRP measurement of the plurality of BPLs based at least on the set of input vectors and beam embedding of the plurality of BPLs.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a base station and a UE communicating using narrow directional beams.

FIG. 5 is a diagram illustrating an example of UE trajectories within a two-dimensional region.

FIG. 6 is a diagram illustrating an example of a beam embedding design.

FIG. 7 is a diagram illustrating an example of a model for beam prediction.

FIG. 8A is a diagram illustrating an example of initiation of a beam prediction procedure.

FIG. 8B is a diagram illustrating an example process of obtaining a beam embedding table.

FIG. 8C is a diagram illustrating an example of termination of a beam prediction procedure.

FIG. 9A is a diagram illustrating an example of temporal subsampling.

FIG. 9B is a diagram illustrating an example of spatial subsampling.

FIG. 10 is a call flow diagram of signaling between a UE, a base station, and a server.

FIG. 11 is a flowchart of a method of wireless communication.

FIG. 12 is a flowchart of a method of wireless communication.

FIG. 13 is a diagram illustrating an example of a hardware implementation for an example apparatus and/or network entity.

FIG. 14 is an illustrative block diagram of an example machine learning (ML) model represented by an artificial neural network (ANN), in accordance with various aspects of the present disclosure.

FIG. 15 is an illustrative block diagram of an example ML architecture for wireless communications, in accordance with various aspects of the present disclosure.

FIG. 16 is an illustrative block diagram of an example ML architecture of first wireless device in communication with second wireless device, in accordance with various aspects of the present disclosure.

### DETAILED DESCRIPTION

Wireless communication, such as wireless communication at millimeter wave (mmWave) frequencies, may be subject to path loss and may be susceptible to blockage from people, hands, buildings, or other structures, among other examples of potential blockages. Both a transmitter (Tx) and a receiver (Rx) may communicate using narrow directional beams to address the aforementioned challenges. However, the use of narrow directional beams may imply that small changes in the orientation of either the transmitter or the receiver, or the appearance of blockages, could result in rapid link quality degradation along certain directions. To identify potential changes in link quality, the transmitter and/or receiver may track and predict the link quality along different beams, so that a device can proactively switch to the best beam and improve system throughput.

Aspects presented herein provide a configuration for beam prediction in the presence of joint spatial and temporal sub-sampling of the input beams. For example, the disclosure may be used for mmWave beam prediction based on mmWave link measurements (standalone mode of operation), where spatial and temporal sub-sampling of input BPL measurements are considered. Aspects presented herein enable a UE to make beam predictions based on cell-specific information, at times. Accurate beam prediction can reduce the beam measurements performed by a UE, which may enable added power savings for the UE. The use of cell-specific information for the beam predictions may improve the accuracy of such predictions, thereby improving beam selection and system throughput.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

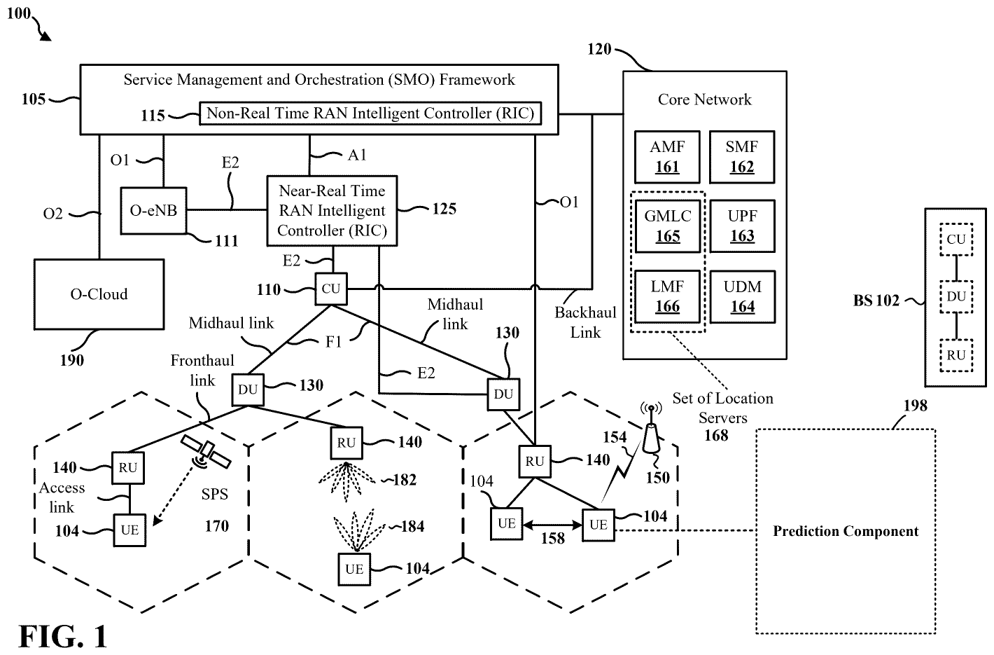

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a prediction component 198 that may be configured to receive an indication to perform a beam prediction procedure; receive a beam embedding table utilized to perform the beam prediction procedure; measure an RSRP for a plurality of BPLs to generate a set of input vectors for the beam prediction procedure, wherein the set of input vectors is generated based at least on the beam embedding table and past RSRP measurements; and predict at least one future RSRP measurement of the plurality of BPLs based at least on the set of input vectors and beam embedding of the plurality of BPLs.

Although the following description may be focused on 5G NR, the concepts described herein may be applicable to other similar areas, such as LTE, LTE-A, CDMA, GSM, and other wireless technologies.

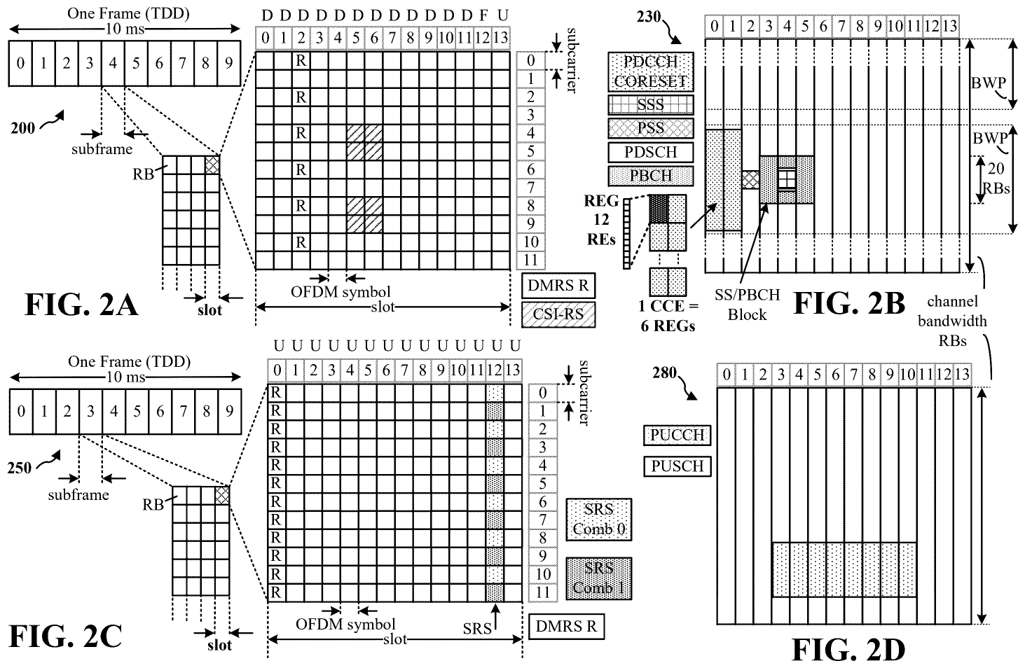

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

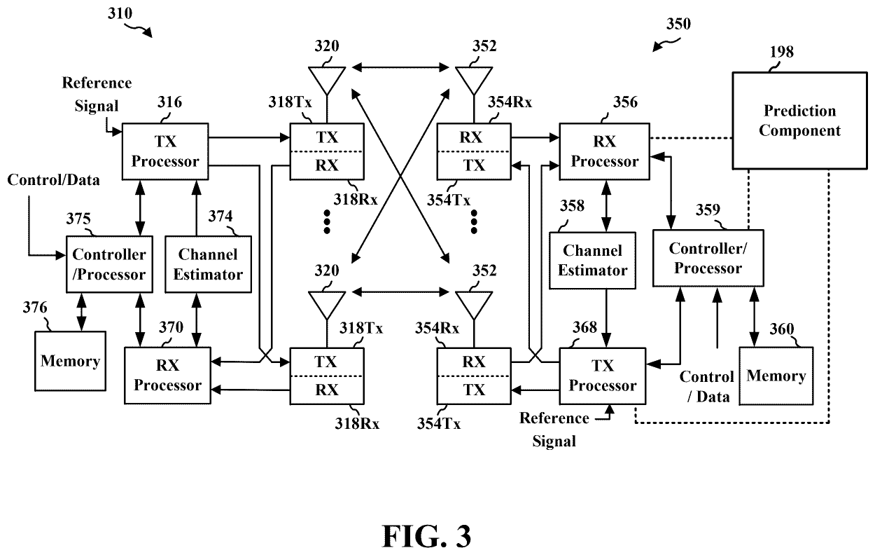

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the prediction component 198 of FIG. 1.

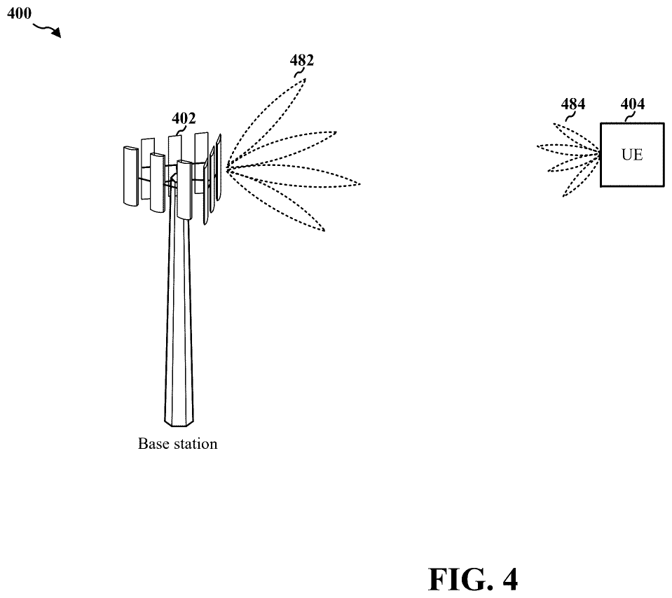

Wireless communication at mm Wave frequencies may be subject to path loss and may be susceptible to blockage from various objects, such as people, hands, vehicles, buildings, or other structures, among various examples. For example, as shown in diagram 400 of FIG. 4, both a Tx and Rx may communicate using narrow directional beams to overcome the aforementioned challenges including potential pathloss and/or blockage. FIG. 4 shows an example of a base station 402 and a UE 404 as examples of a Tx and Rx. In other examples, the Tx and Rx may both be UEs. In some aspects, the base station 402 may be the Tx, and the UE 404 may be the Rx, whereas in other aspects, the base station 402 may be the Rx and the UE 404 may be the Tx. As described in connection with FIG. 1, the base station 402 and the UE 404 may each include a plurality of antennas, such as antenna elements, antenna panels, and/or antenna arrays to facilitate beamforming. The base station 402 may transmit a beamformed signal 482 to the UE 404 in one or more transmit directions. The UE 404 may receive the beamformed signal from the base station 402 in one or more receive directions. The UE 404 may also transmit a beamformed signal 484 to the base station 402 in one or more transmit directions. The base station 402 may receive the beamformed signal from the UE 404 in one or more receive directions.

The use of narrow directional beams may allow small changes in the orientation of either the transmitter or receiver, or the appearance of blockages, to result in rapid link quality degradation along certain directions. The Tx and/or Rx may track and predict the link quality along different beams, so that the Tx and/or Rx can proactively switch to the best beam and improve system throughput. For example, the base station 402 and/or the UE 404 may perform beam training, beam measurement, or beam monitoring to determine the best receive and transmit directions for each of the base station 402 and/or UE 404.

In some aspects, the Tx transmits a beamformed signal, e.g., a wireless signal in a directional beam, by selecting from a codebook of M_{T} transmit beams. The Rx can choose to receive the transmitted signal on any one of the M_{R} receive beams in its codebook. Maintaining link quality may include frequent measurement of received signal power on all M_{T}M_{R} combinations of Tx and Rx beams, henceforth referred to as beam pair links (BPL), to identify the best BPL for wireless communication between the Tx and the Rx. This procedure is known as beam management (BM), e.g., such as described within the 3rd Generation Partnership Project (3GPP) specified fifth generation (5G) New Radio (NR) standards. Beam management may include frequent measurement, quantization and uplink reporting of BPL qualities, which may increase UE power consumption. Such beam management may also be based on frequent transmission of reference signals (RS) to enable the UE to measure a BPL, and the frequency RS transmissions increase downlink (DL) overhead.

To reduce the number of BPLs measured, hierarchical codebooks may be utilized to first measure a small set of wide beams, coarsely identify the transmission direction from the best wide beam and refine this direction by further measurement of a small set of narrow beams. As an example, synchronization signal blocks (SSB) may be broadcast on wide beams periodically (e.g., T=20 ms) for the purpose of cell discovery. The SSBs may be transmitted in bursts of size Lₘₐₓ−henceforth referred to as SSB set (SSBS). Each SSB may correspond to one Tx beam, and the Rx can measure at most Lₘₐₓ BPLs in a SSBS. Having identified the best (e.g., wide beam) BPL, the Tx transmits channel state information reference signals (CSI-RS) on narrower beams, e.g., during data transmission, to refine its transmission direction. In some examples, the aspects presented herein may be applied in connection with the SSB transmissions (e.g., and not CSI-RS), with a view to reducing frequent measurement and reporting of the received power on the SSB beams. Given infrequent SSB measurements, the aspects presented herein enable a wireless communication device, such as a UE, to predict the received power on all possible BPLs for a contiguous set of SSBS, for example. In some examples, the aspects presented herein may be applied in connection with SSB transmissions and other reference signal transmissions, such as CSI-RS transmissions). In some examples, the aspects presented herein may be applied in connection with beam measurements of various signals.

Aspects presented herein provide a configuration for beam prediction in the presence of joint spatial and temporal sub-sampling of the input beams. For example, the disclosure may include mmWave beam prediction based on prior mmWave link measurements (standalone mode of operation), where spatial and temporal sub-sampling of input BPL measurements are considered. Among other potential advantages, the aspects presented herein provide a transformer design configured to predict future RSRP of beam pair links (BPL) seen at the UE given a small set of spatially and temporally subsampled BPLs past RSRPs as input, where each BPL and its measured RSRP are embedded as a token, append CLS tokens and collectively input them to an encoder. The CLS tokens output may be utilized to predict the maximum RSRP, while the memory interacts with the BPL being queried at the decoder to predict its RSRP. Removing self-attention from the decoder enables the decoder to operate on a per-query basis, while the loss functions utilized for training emphasize accurate RSRP prediction of the stronger BPLs over the weaker BPLs. In some aspects, a downlink single user wideband MIMO setup may include a base station (BS) (e.g., such as the base station 402 or 1004) with Nₜ transmit antennas and a UE (e.g., such as the UE 404 or 1002) with Nᵣ receive antennas. The channel on the kth subcarrier may be denoted by Hₖ∈ [symbol] . The same precoding vector f and combining vector w across subcarriers may be utilized. If the BS transmits a unit energy reference signal (RS) s at power level Pₜ and BS antenna gain Gₜ, the signal received on the k^{th} subcarrier yₖ at time t is given by

$${𝒴}_{k} ( t ) = {w}^{H} ( t ) {H}_{k} ( t ) f ( t ) \sqrt{{G}_{t} {P}_{t}} s + n ( t ) ,$$

where n(t)˜CN(0, σ²). Hence, the reference signal receive power (RSRP) is

$$RSRP = \frac{{P}_{t} {G}_{t}}{{σ}^{2}} {\sum }_{k = 1}^{{N}_{f}} {\vert {w}^{H} {H}_{k} f \vert}^{2} ,$$

where N_{f} is the number of subcarriers.

In some aspects, a BPL may be defined as the vector tuple (f, w). For example, f may be drawn from a fixed BS codebook [symbol] containing Mₜ precoding vectors, while w may be drawn from a fixed UE codebook [symbol] containing Mᵣ combining vectors. In this example, each BPL (f, w) may be associated with a BPL ID b∈[MₜMᵣ], and the RSRP measured for BPL b at time t may be denoted by RSRP(b, t). The BPL ID may be determined at the UE side, as the BS may not be aware of the UEs choice of w.

Aspects presented herein may include the UE side of BPL prediction, for example. The UE side of BPL prediction can be formulated mathematically as follows. For a UE that has access to a set of {bᵢₙ, tᵢₙ, RSRP(bᵢₙ, tᵢₙ)} triplets, S_{b}={bᵢₙ} may correspond to the set of input BPL indices, Tᵢₙ={tᵢₙ} corresponds measurement times, and RSRPᵢₙ={RSRP(bᵢₙ, tᵢₙ)} corresponds to the set containing the measured RSRPs. Using this historical input (e.g., prior RSRP measurements), the UE may predict RSRPₒᵤₜ for a set of output BPL indices Q_{b} at the corresponding future time in Tₒᵤₜ.

In some aspects, a beam prediction transformer design may include, input and positional embeddings, a BP encoder, a decoder, and loss functions used to train the transformer encoder and decoder jointly.

The UE may have access to a set of input BPL indices S_{b}={s|s∈[MₜMᵣ]}, RSRP measurements RSRPᵢₙ for each index in S_{b} and the time Tᵢₙ of each measurement. Using this information, the UE may predict the RSRPs (e.g., RSRPₒᵤₜ) for a set of output (query) BPL indices Q_{b}={q|q∈[MₜMᵣ]} at corresponding times in Tₒᵤₜ.

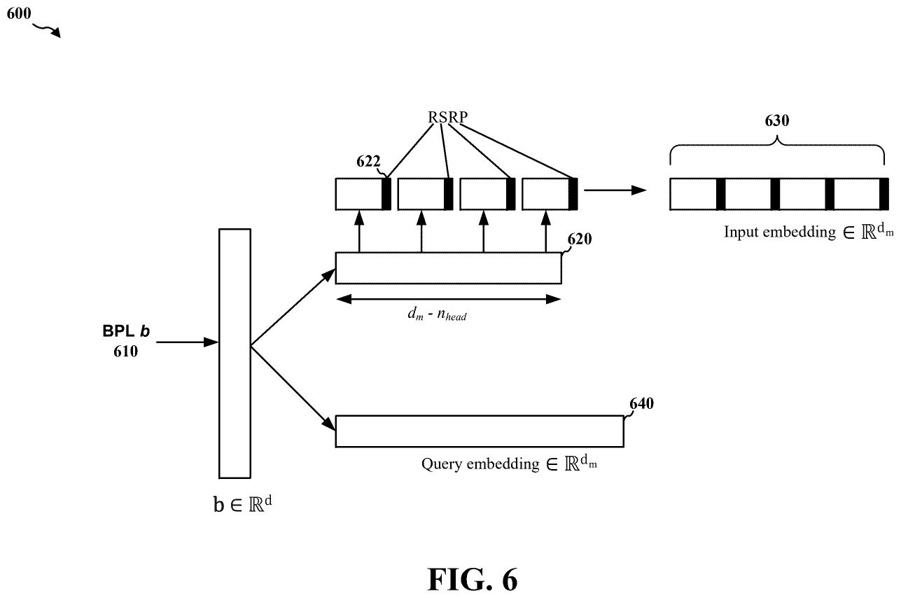

Spatial Embedding may include each BPL b∈[NₜₓMNᵣₓ] (e.g., BPL b 610) associated with a learnable vector b∈ [symbol] . For the sets of beam indices S_{b} and Q_{b}, each index b may be associated with its learnable vector b to obtain vector sets S_{b} and Q_{b} respectively. The learnable vector associated with each index q in Q_{b} may be projected using a linear layer to obtain the set T∈ [symbol] 640. To derive the encoder input set S 630, n_{head} copies of each RSRP 622 in RSRPᵢₙ may be interleaved with the dₘ−n_{head} dimensional projection 620 of the learnable vector associated with the beam indices in S_{b}. The spatial embedding operations are illustrated, for example in diagram 600 of FIG. 6.

Temporal Embedding may include discrete time of measurements t in Tᵢₙ and Tₒᵤₜ, set t′=t/Tₘₐₓ, where Tₘₐₓ is chosen such that t′∈[0, 1]∀t. Utilizing learnable spatial embeddings, random Fourier features may be utilized to compute the temporal embeddings t of Tᵢₙ and Tₒᵤₜ as

$$\begin{matrix}t = [ sin ( 2 π {Bt}^{′} ) & cos ( 2 π {Bt}^{′} ) ] ,\end{matrix}$$

where B˜N(0, 1)^{d}^{ₘ}^{/2} is a vector initialized with random Gaussian entries. In some instances, a common B may be utilized ∀t, and B is not trainable.

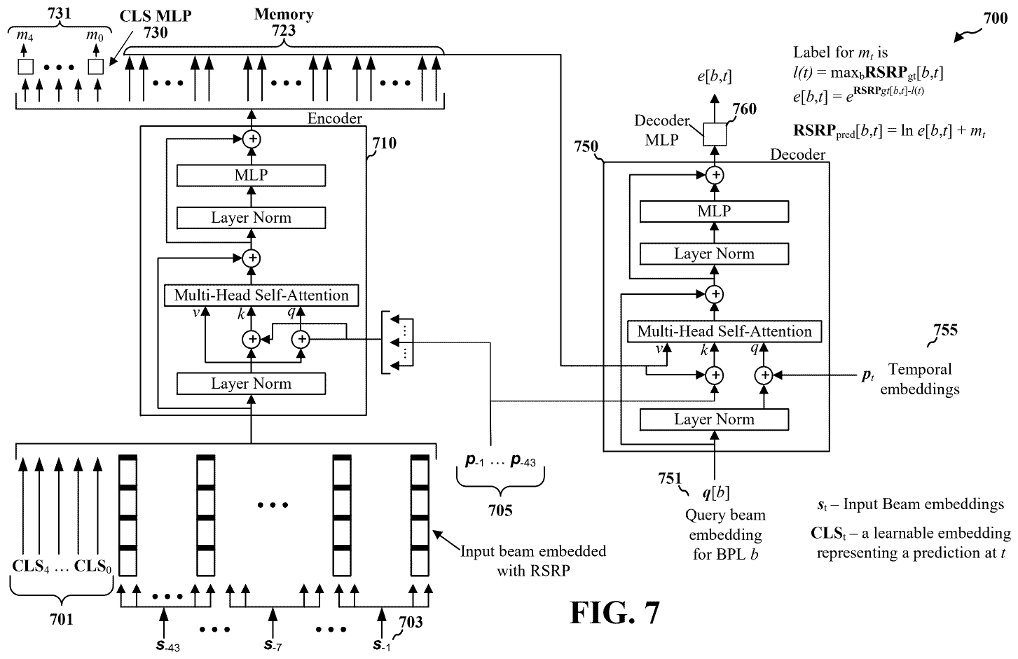

A BP encoder 710 may be adapted from a detection transformer (DETR), while also utilizing classify (CLS) token inputs 701. Each vector sᵢ∈S (e.g., s₋₁ 703) is input to the BP Encoder as shown in diagram 700 of FIG. 7, while its corresponding temporal embedding t_{in,i} is input as positional embedding in place of Pin 705. Additionally, y CLS tokens are appended to each encoder input sequence. Each CLS token clsᵢ∈ [symbol] is a learnable embedding and the encoder output mapping to clsᵢ is passed through a (common) MLP head 730 to obtain the set of mi 731.

A BP decoder 750 may output the RSRP of a BPL with index q∈Q_{b} at time t∈Tₒᵤₜ, given the “memory” 723 output by the encoder—E=[e₁, . . . , e_{|S|}]. The query beam embeddings T may be provided as input to the decoder (instead of setting T=0 as done in DETR) and utilize its corresponding temporal embedding t in place of Pₒᵤₜ. However, this involves passing T through an MSA layer, where each embedding qᵢ∈T interacts with qⱼ∀ⱼ≠i. The RSRP predicted for BPL q at time t could change depending on which other tuples (q′, t′) were part of the decoder input. A solution may include to query the decoder for all qᵢ∈T and all t∈Tₒᵤₜ simultaneously. In some aspects, both the BP encoder and decoder together may be adapted from a DETR. For example, the BP encoder may use the CLS token, and the BO decoder may use a concept of promotability.

In some instances, removal of MSA from the DETR decoder may achieve query independence. In other words, the BP decoder 750 in diagram 700 of FIG. 7 may be viewed on a per-query basis. A single query embedding q 751 may be input to the decoder with its corresponding temporal embedding tₒᵤₜ 755. The query embedding interacts with each of the memory vectors eⱼ∈E in the MCA layer. The output of the decoder is passed through an MLP head 760 with Sigmoid activation to obtain b.

In some aspects, the design of the loss function for training the BP transformer may include some observations. For example, the encoder outputs mapping to the CLS token may be utilized to predict global properties of the output. In addition, the loss function may prioritize correctly predicting RSRP of stronger BPLs over weaker BPLs. For example, if RSRPₒᵤₜ[q, i]<<max_{q} RSRPₒᵤₜ[q, i], the loss function may not penalize errors in RSRP prediction at the same level it would if RSRPₒᵤₜ[q, i]≈max_{q} RSRPₒᵤₜ[q, i]. The labels lₘ_{ᵢ} and l_{b} corresponding to mᵢ and b may be represented as

$${l}_{{m}_{i}} = {max}_{q} {RSRP}_{out} [ q , i ] {l}_{b} = {e}^{R S R {P}_{o ut [ q , i ] - {l}_{{m}_{i} ,}}}$$

where l_{b} is the decoder label for BPL q at time i. Since RSRPₒᵤₜ[q, i]−lₘ_{ᵢ}≤0, this may result in 0<l_{b}_{ᵢ}≤1, justifying the Sigmoid activation at the output of the decoder. The weighted loss function [symbol] (θ_{enc}, θ_{dec}) may be utilized to train the BP encoder and decoder jointly, as given by

$$𝔼 [ {\sum }_{i = 1}^{y} {[ {m}_{i} ( {θ}_{e n c} ) - {l}_{{m}_{i}} ]}^{2} + κ {y ( b ( {θ}_{e n c} , {θ}_{d e c} ) - {l}_{b} )}^{2} ] ,$$

where the outputs are based on the encoder and decoder weights, θ_{enc} and θ_{dec} respectively. In some aspects, the MSE loss at the encoder output may dominate the MSE loss at the Sigmoid activated decoder output, a re-weighting factor κ may be utilized to periodically re-weight the decoder loss during the course of training.

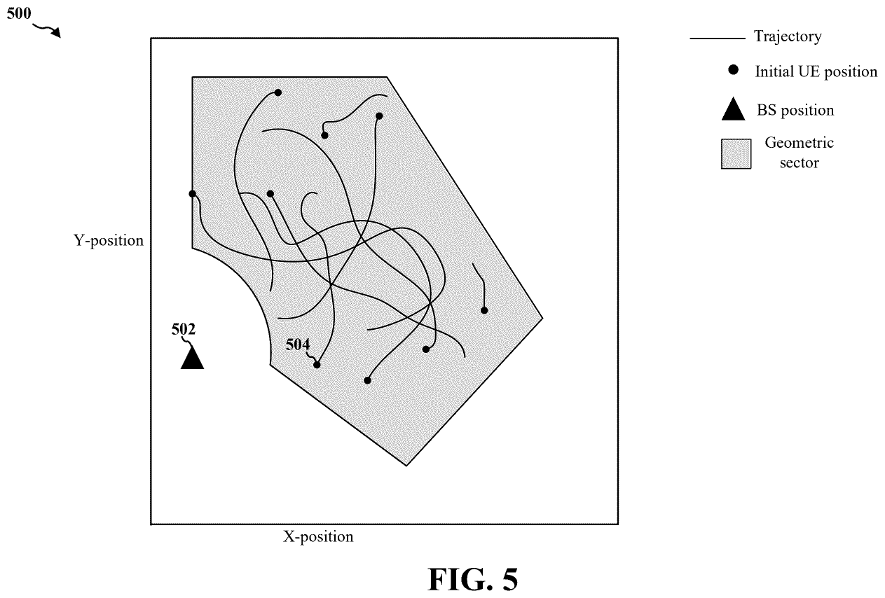

In an example, as shown in diagram 500 of FIG. 5, a UE 504 may move with an azimuthal velocity v in a random trajectory on a two-dimensional plane, while associated with a single base station. The motion of the UE may be within a zone D of the two-dimensional plane. The UE may maintain a constant angular rotational velocity ω. The UE may be randomly assigned an initial position (x₀yₒz₀)∈ [symbol] and an initial 3D orientation (α₀β₀γ₀) in order to generate multiple UE trajectories. The UE position and orientation may evolve over time (e.g., every t_{gran} seconds) in a 3GGP compliant fashion.

In some aspects, a beam management (BM) procedure may include a BM time domain (TD) cycle of T seconds. Every T seconds, the BS 502 sweeps over all f∈ [symbol] , and the UE can measure the RSRP on each precoding vector f using a combining vector w∈ [symbol] . In such instances, the UE may measure at most Mt distinct BPL RSRPs in each BM cycle.

In some aspects, the RSRPs, e.g., measured in dB, may be normalized prior to being input into the BP transformer, and the RSRPs predicted by the BP transformer may be unnormalized prior to being utilized to compute the predictions.

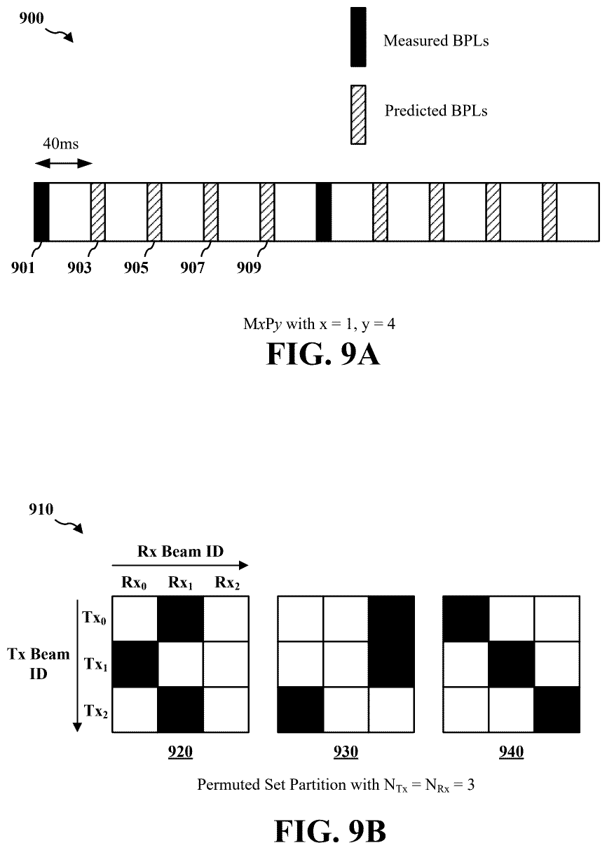

In some aspects, temporal and/or spatial sub-sampling may be utilized. For example, the BS may transmit beams in [symbol] every T seconds, and the UE can feedback the (quantized) RSRP and beam index of the top-Lₘₐₓ beams, as well with the same periodicity. Accurate beam prediction may eliminate the need to perform the operations every T seconds (e.g., 40 ms), which may lead to power savings at the UE as well as uplink overhead reduction. For example, a MxPy model may be utilized for BM with x=1, y=4 (1 beam measurement, e.g., BM 901, followed by 4 beam predictions, e.g., beam prediction 903, beam prediction 905, beam prediction 907, and beam prediction 909), such that BM will be performed every (x+y)*T seconds, with the objective of predicting the BPL RSRPs in the y contiguous BM cycles that follow every x measured BM cycles, as shown for example in diagram 900 in FIG. 9A.

Spatial sub-sampling may result in not measuring the RSRP of all MₜMᵣ BPLs every BM cycle, such that only Mₜ (or N_{Tx}) BPL RSRPs, one for each beam in [symbol] , may be measured. In every BM cycle, each beam f∈ [symbol] may be measured using a random beam w∈ [symbol] . Each BPL b∈[MₜMᵣ] may be measured once, across Mᵣ (or N_{Rx}) measured BM cycles, for example. An example of spatial sub-sampling with Mₜ=Mᵣ=3 is, shown for example in diagram 910 of FIG. 9B. For example, during a first measurement cycle 920 (e.g., BM cycle) the base station may transmit three transmission beams in [symbol] (e.g., with IDs 0, 1, and 2) that may be measured by receive beams from a set of three receive beams in [symbol] (e.g., with IDs 0, 1, and 2), such that a first Tx beam (with ID 0 or Tx₀) is received by a second Rx beam (with ID 1 or Rx₁), a second Tx beam (with ID 1 or Tx₁) is received by a first Rx beam (with ID 0 or Rx₀), and a third Tx beam (with ID 2 or Tx₂) is received by the second Rx beam. Similarly, during a second measurement cycle 930 the base station may transmit and the UE may measure signals such that the first Tx beam is received by a third Rx beam (with ID 2 or Rx₂), the second Tx beam is received by the third Rx beam, and the third Tx beam is received by the first Rx beam. For a third measurement cycle 940 the base station may transmit and the UE may measure signals such that the first Tx beam is received by the first Rx beam, the second Tx beam is received by the second Rx beam, and the third Tx beam is received by the third Rx beam. As illustrated, each beam pair (or BPL) is measured once over the course of three measurement cycles, where the total number of cycles may be larger or smaller depending on the number of BPLs to measure (e.g., depending on the size of M&M, and/or the number of receive beams that can be used to measure a single transmitted beam).

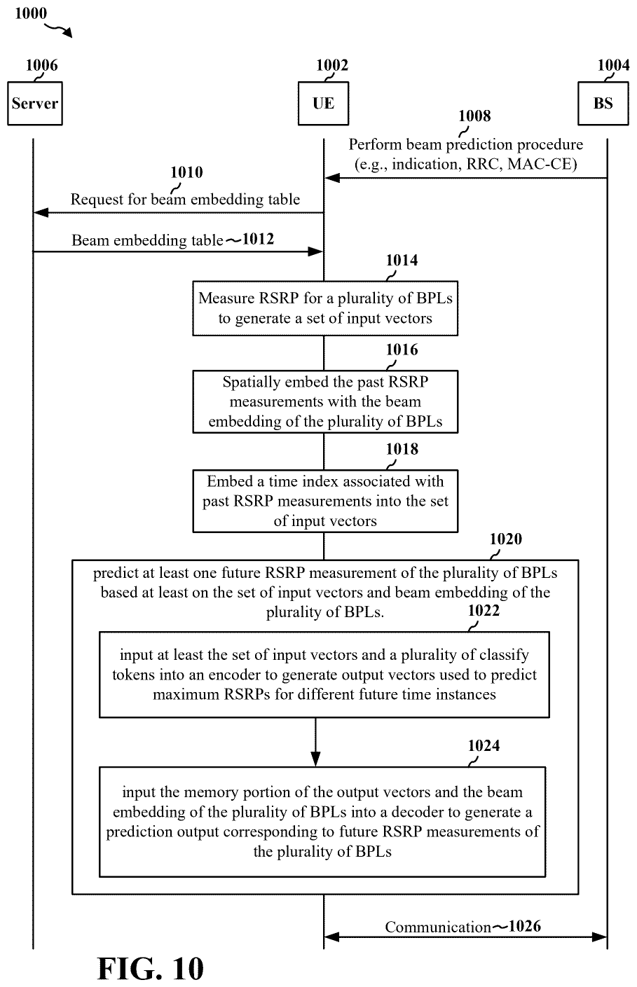

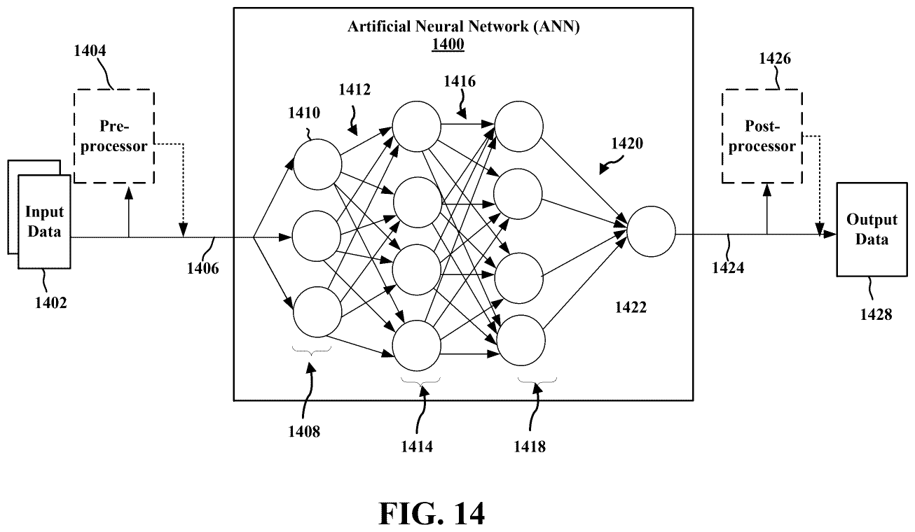

FIG. 10 is a call flow diagram 1000 of signaling between a UE 1002 and a base station 1004 (e.g., as an example of a network node or network entity that may include one or more components of a base station, such as one or more of a CU, DU and/or RU). Some aspects performed by the base station 1004 may be performed by a base station in aggregation, and some aspects may be performed by one or more disaggregated components of a base station. The base station 1004 may be configured to provide at least one cell. The UE 1002 may be configured to communicate with the base station 1004. For example, in the context of FIG. 1, the base station 1004 may correspond to base station 102 and the UE 1002 may correspond to at least UE 104. In another example, in the context of FIG. 3, the base station 1004 may correspond to base station 310 and the UE 1002 may correspond to UE 350. The UE may use a foundational model for beam prediction, and may use particular embedding tables, such as cell-specific beam embedding tables, for beam predictions. As described in connection with FIG. 1, models may include AI/ML models. FIGS. 14, 15, and 16 illustrate various aspects of models.

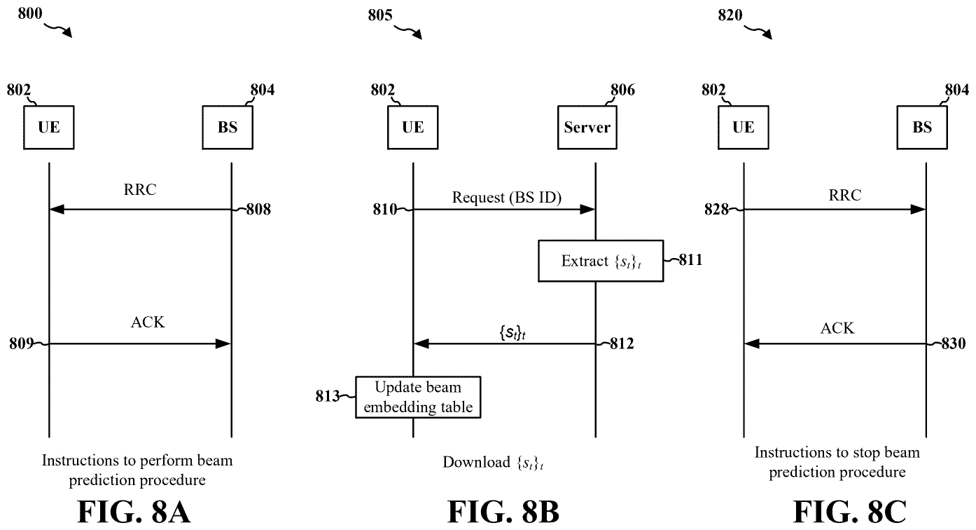

At 1008, the base station 1004 may provide, to the UE 1002, an indication to perform a beam prediction procedure. The UE may receive the indication to perform the beam prediction procedure from the base station 1004. In some aspects, the indication to perform the beam prediction procedure may be included within RRC signaling and/or a medium access control-control element (MAC-CE), as shown for example in diagram 800 of FIG. 8A (e.g., via RRC signaling 808 from the base station 804 to the UE 802, followed by an acknowledgment 809 from the UE 802 to the base station 804, where UE 802 of FIGS. 8A, 8B and 8C correspond to UE 1002 of FIG. 10 and base station 804 of FIGS. 8A and 8C correspond to base station 1004 of FIG. 10). In some aspects, as shown for example in diagram 820 of FIG. 8C, the base station 804 may provide instructions to the UE 802 to stop performing the beam prediction procedure via RRC signaling 828 and the UE may provide to the base station 804 an acknowledgment 830. For example, the base station may instruct the UE to stop performing the beam prediction procedure, e.g., in instances where the beam prediction results are negatively impacting performance. In some aspects, in response to the indication from the base station, the UE may resume use of a prior set of beam prediction algorithms.

At 1010, the UE 1002 may transmit a request for a beam embedding table associated with the base station 1004, as shown for example in diagram 805 of FIG. 8B. As an example, the base station may indicate an identifier (e.g., such as a cell identifier or base station identifier) to the UE 1002 via the indication at 1008 (or to the UE 802 via the RRC signaling 808). The UE 802 may transmit, to a server 806 of FIG. 8B corresponding to server 1006 of FIG. 10, the request 810 for the beam embedding table associated with the base station or cell. The request 810 may include an identifier (ID) of the cell or the base station 804 (or the request transmitted at 1010 may include an ID of the base station 1004). In some aspects, the beam embedding table may correspond to the ID of the base station 1004, such that the beam embedding table may be specific to the base station 1004. In some aspects, the beam embedding table may be a cell-specific beam embedding table. In some aspects, the UE may request a beam embedding table for a different base station by including the ID corresponding to the different base station in the request, where the different base station is serving the UE.

At 1012, the server 1006 may provide the beam embedding table associated with the base station 1004 to the UE 1002. The UE may receive the beam embedding table from the server 1006. The UE may receive the beam embedding table that may be utilized to perform the beam prediction procedure, as shown for example in diagram 805 of FIG. 8B. For example, based on the request 810, the server 806 may, at 811, identify (or extract) a set of spatial embeddings (e.g., a beam embedding table {sₜ}ₜ). The server 806 may transmit, and the UE 802 may receive, the identified and/or extracted spatial embeddings 812 as a spatial embedding table (e.g., {sₜ}ₜ). Based on the spatial embedding table included in the identified and/or extracted spatial embeddings 812, the UE 802 may, at 813, update a beam embedding table associated with the base station 804 or the base station 1004.

At 1014, the UE may measure an RSRP for a plurality of BPLs to generate a set of input vectors for the beam prediction procedure. The set of input vectors may be generated based at least on the beam embedding table and past RSRP measurements for the plurality of BPLs.

At 1016, the UE may spatially embed the past RSRP measurements with the beam embedding of the plurality of BPLs. The UE may spatially embed the past RSRP measurements with the beam embedding of the plurality of BPLs on which RSRP measurements were collected to form the set of input vectors.

At 1018, the UE may embed a time index associated with the past RSRP measurements into the set of input vectors.

At 1020, the UE may predict at least one future RSRP measurement of the plurality of BPLs. The UE may predict at least one future RSRP measurement of the plurality of BPLs based at least on the set of input vectors and beam embedding of the plurality of BPLs.

At 1022, the UE, to predict the future measurements of the plurality of BPLs, may input at least the set of input vectors and a plurality of classify tokens into an encoder to generate output vectors used to predict maximum RSRPs for different future time instances. In some aspects, each of the plurality of classify tokens may be associated with the different future time instances. In some aspects, the output vectors may include a memory portion and the maximum RSRP at the different future time instances.

At 1024, the UE, to predict the future measurements of the plurality of BPLs, may input the memory portion of the output vectors and the beam embedding of the plurality of BPLs into a decoder to generate a prediction output corresponding to future RSRP measurements of the plurality of BPLs.

At 1026, the UE may communicate with the base station using a predicted BPL based at least on the prediction of at least one future RSRP measurement of the plurality of BPLs.

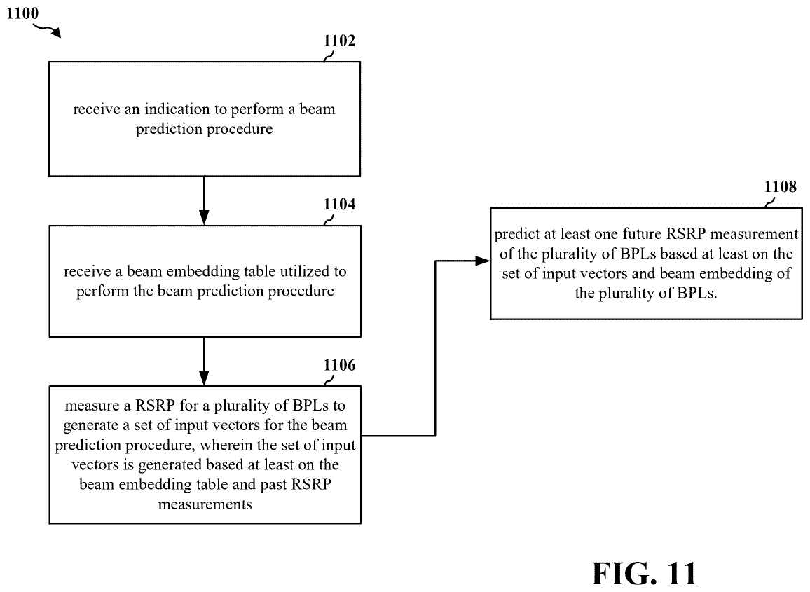

FIG. 11 is a flowchart 1100 of a method of wireless communication. The method may be performed by a UE (e.g., the UE 104; the apparatus 1304). One or more of the illustrated operations may be omitted, transposed, or contemporaneous. The method may allow a UE to perform beam prediction based at least on beam pair link measurements.

At 1102, the UE may receive an indication to perform a beam prediction procedure. For example, 1102 may be performed by prediction component 198 of apparatus 1304. The UE may receive the indication to perform the beam prediction procedure from a first network entity. In some aspects, the indication to perform the beam prediction procedure may be received via RRC signaling or MAC-CE.

At 1104, the UE may receive a beam embedding table. For example, 1104 may be performed by prediction component 198 of apparatus 1304. The UE may receive the beam embedding table that may be utilized to perform the beam prediction procedure. The UE may receive the beam embedding table from a second network entity.

At 1106, the UE may measure an RSRP for a plurality of BPLs. For example, 1106 may be performed by prediction component 198 of apparatus 1304. The UE may measure the RSRP for the plurality of BPLs to generate a set of input vectors for the beam prediction procedure. The set of input vectors may be generated based at least on the beam embedding table and past RSRP measurements for the plurality of BPLs.

At 1108, the UE may predict at least one future RSRP measurement of the plurality of BPLs. For example, 1108 may be performed by prediction component 198 of apparatus 1304. The UE may predict at least one future RSRP measurement of the plurality of BPLs based at least on the set of input vectors and beam embedding of the plurality of BPLs.

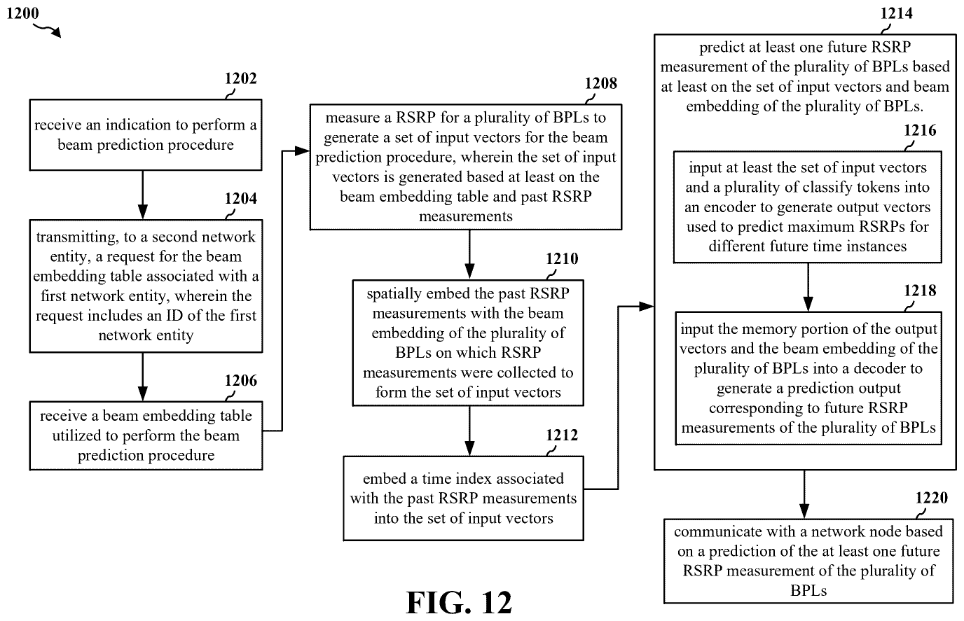

FIG. 12 is a flowchart 1200 of a method of wireless communication. The method may be performed by a UE (e.g., the UE 104; the apparatus 1304). One or more of the illustrated operations may be omitted, transposed, or contemporaneous. The method may allow a UE to perform beam prediction based at least on beam pair link measurements.

At 1202, the UE may receive an indication to perform a beam prediction procedure. For example, 1102 may be performed by prediction component 198 of apparatus 1304. The UE may receive the indication to perform the beam prediction procedure from a first network entity. In some aspects, the indication to perform the beam prediction procedure may be received via RRC signaling or MAC-CE.

At 1204, the UE may transmit a request for a beam embedding table. For example, 1204 may be performed by prediction component 198 of apparatus 1304. The UE may transmit the request for the beam embedding table associated with a first network entity. The UE may transmit, to a second network entity, the request for the beam embedding table associated with the first network entity. The request may include an ID of the first network entity. In some aspects, the beam embedding table may correspond to the ID of the first network entity, such that the beam embedding table may be specific to the first network entity.

At 1206, the UE may receive a beam embedding table. For example, 1206 may be performed by prediction component 198 of apparatus 1304. The UE may receive the beam embedding table that may be utilized to perform the beam prediction procedure. The UE may receive the beam embedding table from a second network entity.

At 1208, the UE may measure an RSRP for a plurality of BPLs. For example, 1208 may be performed by prediction component 198 of apparatus 1304. The UE may measure the RSRP for the plurality of BPLs to generate a set of input vectors for the beam prediction procedure. The set of input vectors may be generated based at least on the beam embedding table and past RSRP measurements for the plurality of BPLs.

At 1210, the UE may spatially embed the past RSRP measurements with the beam embedding of the plurality of BPLs. For example, 1210 may be performed by prediction component 198 of apparatus 1304. The UE may spatially embed the past RSRP measurements with the beam embedding of the plurality of BPLs on which RSRP measurements were collected to form the set of input vectors.

At 1212, the UE may embed a time index associated with the past RSRP measurements into the set of input vectors. For example, 1212 may be performed by prediction component 198 of apparatus 1304.

At 1214, the UE may predict at least one future RSRP measurement of the plurality of BPLs. For example, 1214 may be performed by prediction component 198 of apparatus 1304. The UE may predict at least one future RSRP measurement of the plurality of BPLs based at least on the set of input vectors and beam embedding of the plurality of BPLs.

At 1216, the UE, to predict the future measurements of the plurality of BPLs, may input at least the set of input vectors and a plurality of classify tokens into an encoder. For example, 1216 may be performed by prediction component 198 of apparatus 1304. The UE may input at least the set of input vectors and a plurality of classify tokens into an encoder to generate output vectors used to predict maximum RSRPs for different future time instances. In some aspects, each of the plurality of classify tokens may be associated with the different future time instances. In some aspects, the output vectors may include a memory portion and the maximum RSRP at the different future time instances.

At 1218, the UE, to predict the future measurements of the plurality of BPLs, may input the memory portion of the output vectors and the beam embedding of the plurality of BPLs into a decoder. For example, 1218 may be performed by prediction component 198 of apparatus 1304. The UE may input the memory portion of the output vectors and the beam embedding of the plurality of BPLs into the decoder to generate a prediction output corresponding to future RSRP measurements of the plurality of BPLs.

As shown at 1220, the UE may communicate with a network node based on a prediction of the at least one future RSRP measurement of the plurality of BPLs. For example, the UE may transmit or receive communication with the network node using a beam selected based on the prediction of the at least one future RSRP measurement. In some aspects, the UE may report beam quality information based on the prediction of the at least one future RSRP measurement. FIG. 10 illustrates an example of a UE communicating with a base station based on a prediction of future RSRO measurement(s) at 1026. For example, 1220 may be performed by prediction component 198 of apparatus 1304.

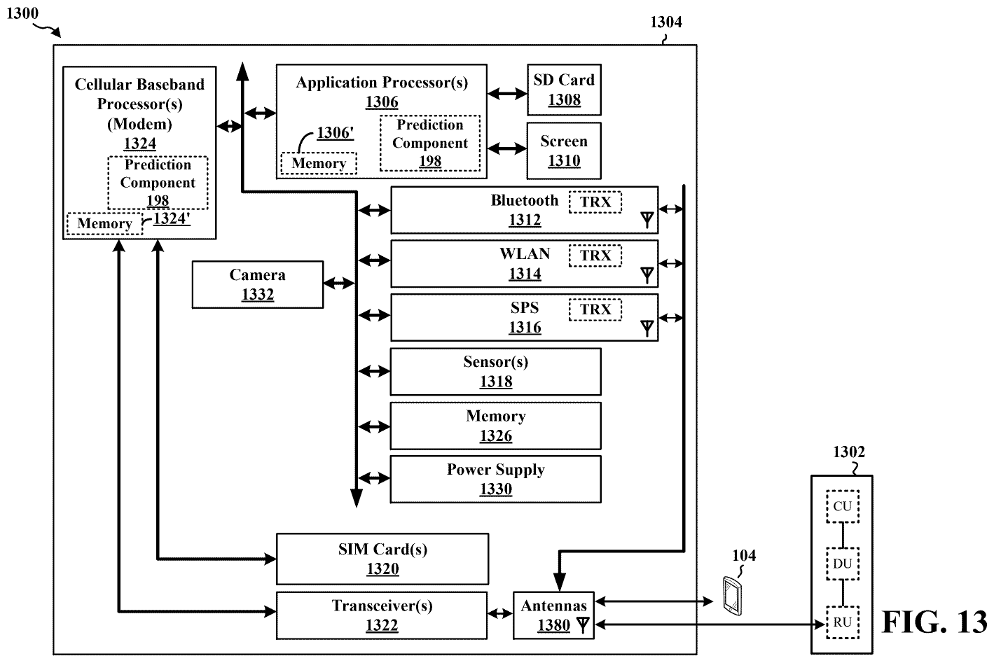

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) 1324 communicates through the transceiver(s) 1322 via one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The cellular baseband processor(s) 1324 and the application processor(s) 1306 are configured to perform the various functions described supra based at least in part of the information stored in the memory. That is, the cellular baseband processor(s) 1324 and the application processor(s) 1306 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, the component 198 may be configured to receive an indication to perform a beam prediction procedure; receive a beam embedding table utilized to perform the beam prediction procedure; measure an RSRP for a plurality of BPLs to generate a set of input vectors for the beam prediction procedure, wherein the set of input vectors is generated based at least on the beam embedding table and past RSRP measurements; and predict at least one future RSRP measurement of the plurality of BPLs based at least on the set of input vectors and beam embedding of the plurality of BPLs. The component 198 may be within the cellular baseband processor(s) 1324, the application processor(s) 1306, or both the cellular baseband processor(s) 1324 and the application processor(s) 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, may include means for receiving an indication to perform a beam prediction procedure. The apparatus includes means for receiving a beam embedding table utilized to perform the beam prediction procedure. The apparatus includes means for measuring an RSRP for a plurality of BPLs to generate a set of input vectors for the beam prediction procedure, wherein the set of input vectors is generated based at least on the beam embedding table and past RSRP measurements. The apparatus includes means for predicting at least one future RSRP measurement of the plurality of BPLs based at least on the set of input vectors and beam embedding of the plurality of BPLs. The apparatus further includes means for transmitting, to a second network entity, a request for the beam embedding table associated with a first network entity, wherein the request includes an ID of the first network entity. The apparatus further includes means for spatially embedding the past RSRP measurements with the beam embedding of the plurality of BPLs on which RSRP measurements were collected to form the set of input vectors. The apparatus further includes means for embedding a time index associated with the past RSRP measurements into the set of input vectors. The apparatus further includes means for inputting at least the set of input vectors and a plurality of classify tokens into an encoder to generate output vectors used to predict maximum RSRPs for different future time instances. The apparatus further includes means for inputting the memory portion of the output vectors and the beam embedding of the plurality of BPLs into a decoder to generate a prediction output corresponding to future RSRP measurements of the plurality of BPLs. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

Some aspects and techniques as described herein may be implemented, at least in part, using an artificial intelligence (AI) program, such as a program that includes a machine learning (ML) or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights.

In some aspects, an ML model may be configured to provide computing capabilities for wireless communications. Such an ML model may be configured with weights and biases to perform beam predictions. Thus, during operation of a device, the ML model may receive input data prior beam measurement and make inferences of beam prediction based on the weights and biases. As described herein, the output may be based on cell-specific beam embedding tables.

ML models may be deployed in one or more devices (for example, network entities and user equipments (UEs)) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization, channel state estimation, channel equalization, channel state feedback, modulation, demodulation, device positioning, beamforming, load balancing, operations and management functions, security, etc.

ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values which are not bounded by predefined output values. For example, a classification ML model configured according to aspects of this disclosure may produce an output which includes beam prediction. A regression ML model configured according to embodiments of this disclosure may produce an output which includes beam prediction. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc.

The description herein illustrates, by way of some examples, how one or more tasks or problems in wireless communications may benefit from the application of one or more ML models for beam prediction. To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML mode,” “ANN,” “model,” “algorithm,” or the like are intended to be interchangeable.

FIG. 14 is an illustrative block diagram of an example machine learning (ML) model represented by an artificial neural network (ANN) 1400. ANN 1400 may receive input data 1406 which may include one or more bits of data 1402, pre-processed data output from pre-processor 1404 (optional), or some combination thereof. Here, data 1402 may include training data, verification data, application-related data, or the like, based, for example, on the stage of deployment of ANN 1400. Pre-processor 1404 may be included within ANN 1400 in some other implementations. Pre-processor 1404 may, for example, process all or a portion of data 1402 which may result in some of data 1402 being changed, replaced, deleted, etc. In some implementations, pre-processor 1404 may add additional data to data 1402. In some implementations, the pre-processor 1404 may be a ML model, such as an ANN.

The ANN 1400 includes at least one first layer 1408 of artificial neurons 1410 to process input data 1406 and provide resulting first layer data via connections or “edges” such as edges 1412 to at least a portion of at least one second layer 1414. Second layer 1414 processes data received via edges 1412 and provides second layer output data via edges 1416 to at least a portion of at least one third layer 1418. Third layer 1418 processes data received via edges 1416 and provides third layer output data via edges 1420 to at least a portion of a final layer 1422 including one or more neurons to provide output data 1424. All or part of output data 1424 may be further processed in some manner by (optional) post-processor 1426. Thus, in certain examples, ANN 1400 may provide output data 1428 that is based on output data 1424, post-processed data output from post-processor 1426, or some combination thereof.

Post-processor 1426 may be included within ANN 1400 in some other implementations. Post-processor 1426 may, for example, process all or a portion of output data 1424 which may result in output data 1428 being different, at least in part, to output data 1424, as result of data being changed, replaced, deleted, etc. In some implementations, post-processor 1426 may be configured to add additional data to output data 1424. In this example, second layer 1414 and third layer 1418 represent intermediate or hidden layers that may be arranged in a hierarchical or other like structure. Although not explicitly shown, there may be one or more further intermediate layers between the second layer 1414 and the third layer 1418. In some implementations, the post-processor 1426 may be a ML model, such as an ANN.

The structure and training of artificial neurons 1410 in the various layers may be tailored to specific requirements of an application. Within a given layer such as first layer 1408, second layer 1414, or third layer 1418 of ANN 1400, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of ANN 1400. The weights and biases of ANN 1400 may be adjusted during a training process or during operation of ANN 1400. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 1406. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 1400, may be conducted using training data. Training data may include one or more datasets which ANN 1400 may use to identify patterns or relationships. Training data may represent various types of information, including written, visual, audio, environmental context, operational properties, etc. During training, the parameters (such as the weights and biases) of artificial neurons 1410 may be changed, such as to minimize or otherwise reduce a loss function or a cost function. A training process may be repeated multiple times to fine-tune ANN 1400 with each iteration.

Various ANN model structures are available for consideration. For example, in a feedforward ANN structure, each artificial neuron 1410 in layer A14 receives information from the previous layer (such as, one or more artificial neurons 1410 in layer 1408) and produces information for the next layer (such as, one or more artificial neurons 1410 in layer 1418). In a convolutional ANN structure, some layers may be organized into filters that extract features from data, such as the training data or the input data. In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer ANN structure may include a series of feedforward ANN layers whose configurations may change in response to identifying non-linear relationships between the input and output sequences, which may also be referred to as a process of “learning” by the ANN layers. The output of a transformer ANN structure may be obtained by applying a linear transformation to the output of a final attention layer. A transformer ANN structure may be of particular use for tasks that involve sequence modeling, or other like processing.

Another example type of ANN structure is a model with one or more invertible layers. Models of this type may be inverted or “unwrapped” to reveal the input data that was used to generate the output of a layer. Other example types of ANN model structures include fully connected neural networks (FCNNs) and long short-term memory (LSTM) networks.

ANN 1400 or other ML models may be implemented in various types of processing circuits along with memory and applicable instructions therein. For example, general-purpose hardware circuits, such as, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed. In some implementations, the ML model may be implemented by a NPU or a TPU embedded in a system on chip (SoC) along with other components, such as one or more CPUs, GPUs, etc. A SoC includes several components manufactured on a shared semiconductor substrate. The NPU or TPU may be controlled by the one or more CPUs by configuring the ML model implemented by the NPU or TPU with weights and biases, providing certain training data to the ML model to configure the ML model, or providing input data to the ML model to obtain related inferences. The one or more CPUs may also receive the inferences and be configured to perform certain actions based on the inferences produced by the ML model. The actions performed by the one or more CPUs may include sending commands to other components of the SoC or components external to the SoC to perform certain actions. For example, the CPU may send commands to a RF transceiver based on the outputs or inferences obtained from an ML model to cause the RF transceiver to operate on a wireless network in accordance with the ML model.

In example aspects, an ML model may be trained prior to, or at some point following, operation of the ML model, such as ANN 1400, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a user equipment (UE) or other device in a wireless communication system, or one or more network entities, or aggregated from multiple sources (such as a UE and a network entity/entities, one or more other UEs, the Internet, or the like). For example, wireless network architectures, such as self-organizing networks (SON) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like.

Offline training may refer to creating and using a static training dataset, such as, in a batched manner, whereas online training may refer to a real-time collection and use of training data. For example, an ML model at a network device (such as, a UE) may be trained or fine-tuned using online or offline training. For offline training, data collection and training can occur in an offline manner at the network side (such as, at a base station or other network entity) or at the UE side. For online training, the training of a UE-side ML model may be performed locally at the UE or by a server device (such as, a server hosted by a UE vendor) in a real-time or near-real-time manner based on data provided to the server device from the UE. In certain instances, all or part of the training data may be shared within in a wireless communication system, or even shared (or obtained from) outside of the wireless communication system.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, re-training it on the data, or using different optimization techniques, etc.

As part of a training process, parameters affecting the functioning of the artificial neurons and layers may be adjusted. For example, backpropagation techniques may be used to train an ANN by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases as needed to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an on-going training process early, such as when a performance of the model using a validation dataset starts to degrade.

Another example technique includes data augmentation to generate additional training data by applying transformations to all or part of the training information. A transfer learning technique may be used which involves using a pre-trained model as a starting point for training a new model, which may be useful when training data is limited or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ANN is a “pruning” technique. A pruning technique, which may be performed during a training process or after a model has been trained, involves the removal of unnecessary or less necessary, or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored. Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain example implementations, pruning techniques also may be applied to training data, for example, to remove outliers. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. Some example training processes that may be used to train an ANN include supervised learning, unsupervised learning, semi-supervised learning, and reinforcement learning technique. With supervised learning, a model is trained on a labeled training dataset, wherein the input data is accompanied by a correct or otherwise acceptable output. With unsupervised learning, a model is trained on an unlabeled training dataset, such that the model will need to learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize a behavior of a model deployed in a dynamically changing environment, such as a wireless communication network.

Distributed, shared, or collaborative learning techniques may be used for the training process. For example, techniques such as federated learning may be used to decentralize the training process and rely on multiple devices, network entities, or organizations for training various versions or copies of a ML model, without relying on a centralized training mechanism. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ANN to be trained on data collected from a wide range of devices and environments. For example, an ANN may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a global or shared model and perform local training on the local model using locally available training data. The UE may provide update information regarding the locally trained model to one or more other devices (such as a network entity or a server) where the updates from other-like devices (such as other UEs) may be aggregated and used to provide an update to global or shared model. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network entity such as a base station, or a disaggregated network entity such as a central unit (CU), a distributed unit (DU), a radio unit (RU), or the like.

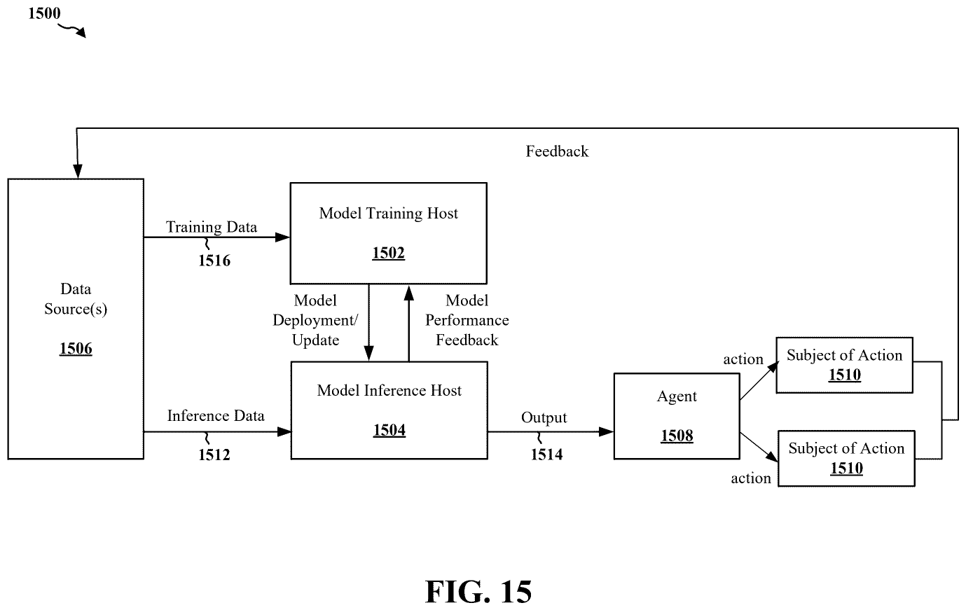

FIG. 15 is an illustrative block diagram of an example ML architecture 1500 that may be used for wireless communications in any of the various implementations, processes, environments, networks, or use cases listed above. As illustrated, architecture 1500 includes multiple logical entities, such as model training host 1502, model inference host 1504, data source(s) 1506, and agent 1508. Model inference host 1504 is configured to run an ML model based on inference data 1512 provided by data source(s) 1506. Model inference host 1504 may produce output 1514, which may include a prediction or inference, such as a discrete or continuous value based on inference data 1512, which may then be provided as input to the agent 1508.

Agent 1508 may represent an element or an entity of a wireless communication system including, for example, a radio access network (RAN), a wireless local area network, a device-to-device (D2D) communications system, etc. As an example, agent 1508 may be a user equipment (such as UE 104, referring to FIG. 1, for example), a base station (such as base station 102, referring to FIG. 1, for example), or a disaggregated network entity (such as a CU 110, DU 130, or RU 140 in FIG. 1), an access point, a wireless station, a RAN intelligent controller (RIC) in a cloud-based RAN, among some examples. Additionally, agent 1508 also may be a type of agent that depends on the type of tasks performed by model inference host 1504, the type of inference data 1512 provided to model inference host 1504, or the type of output 1514 produced by model inference host 1504. For example, the agent may be a UE that selects a beam based on an inference of a beam quality via the model.

Agent 1508 may perform one or more actions associated with receiving output 1514 from model inference host 1504. Agent 1508 may indicate the one or more actions performed to at least one subject of action 1510. In some cases, agent 1508 and the subject of action 1510 are the same entity.

Data can be collected from data sources 1506, and may be used as training data 1516 for training an ML model, or as inference data 1512 for feeding an ML model inference operation. Data sources 1506 may collect data from various subject of action 1510 entities (such as, the UE or the network entity), and provide the collected data to a model training host 1502 for ML model training. In some examples, if output 1514 provided to agent 1508 is inaccurate (or the accuracy is below an accuracy threshold), model training host 1502 may provide feedback to model inference host 1504 to modify or retrain the ML model used by model inference host 1504, such as via an ML model deployment update.

Model training host 1502 may be deployed at the same or a different entity than that in which model inference host 1504 is deployed. For example, in order to offload model training processing, which can impact the performance of model inference host 1504, model training host 1502 may be deployed at a model server.

In some other aspects, an ML model is deployed at or on a UE (such as UE 104) for beam prediction. More specifically, a model inference host, such as model inference host 1504 in FIG. 15, may be deployed at or on the UE for beam prediction.

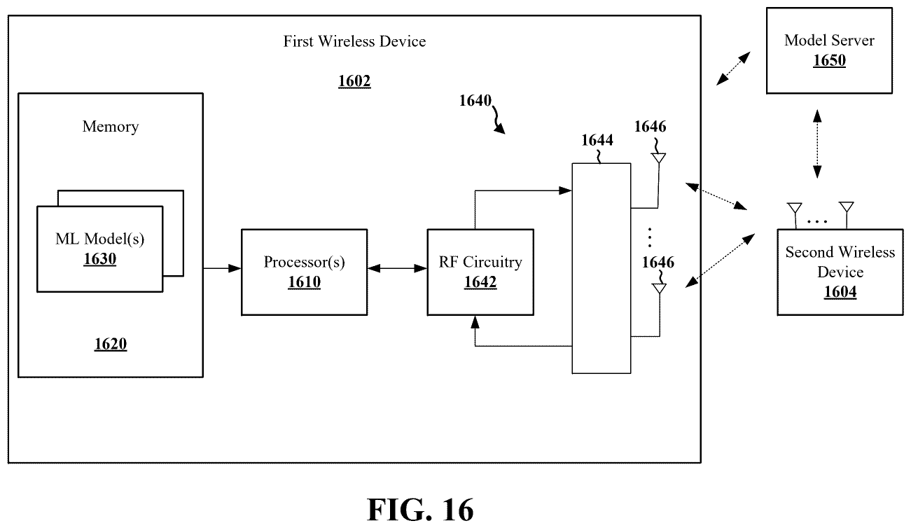

FIG. 16 is an illustrative block diagram of an example ML architecture of first wireless device 1602 in communication with second wireless device 1604. First wireless device 1602 may be configured for beam prediction, and may correspond to the UE 1002, for example. Similarly, the second wireless device may be configured for wireless communication with the first wireless device 1602 and may correspond to the base station 1004. The example ML architecture of first wireless device 1602 may be applied to second wireless device 1604, and vice versa.

First wireless device 1602 may be, or may include, a chip, system on chip (SoC), chipset, package or device that includes one or more processors, processing blocks or processing elements (collectively “processor 1610”) and one or more memory blocks or elements (collectively “memory 1620”). Processor 1610 may be coupled to transceiver, which includes radio frequency (RF) circuitry 1642 coupled to antennas 1646 via interface 1644, for transmitting or receiving signals.

One or more ML models 1630 (collectively “ML model 1630”) may be stored in memory 1620 and accessible to processor(s) 1610. Individual or groups of ML models 1630 may be associated with respective model identifiers. In some aspects, different ML models 1630, which may optionally be associated with different model identifiers, may have different characteristics. One or more ML models 1630 may be selected based on respective features, characteristics, or applications, as well as characteristics or conditions of first wireless device 1640 (such as, a power state, a mobility state, a battery reserve, a temperature, etc.). For example, ML models 1630 may have different inference data and output pairings (such as, different types of inference data produce different types of output), different levels of accuracies associated with the predictions, different latencies associated with producing the predictions, different ML model sizes, different coefficients, different parameters, etc.

Processor 1610 may deploy ML models 1630 to produce respective output data based on input data. For example, the first wireless device may be configured to perform beam prediction, e.g., as described in connection with the UE 1002 in FIG. 10.

In some aspects, model server 1650 may perform various ML management tasks for first wireless device 1602 and/or second wireless device 1604, e.g., including providing the embedding table, such as described in connection with the server 1006 in FIG. 10.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is the method of wireless communication at a UE comprising receiving an indication to perform a beam prediction procedure; receiving a beam embedding table utilized to perform the beam prediction procedure; measuring an RSRP for a plurality of BPLs to generate a set of input vectors for the beam prediction procedure, wherein the set of input vectors is generated based at least on the beam embedding table and past RSRP measurements; and predicting at least one future RSRP measurement of the plurality of BPLs based at least on the set of input vectors and beam embedding of the plurality of BPLs.

Aspect 2 is the method of aspect 1, further including transmitting, to a second network entity, a request for the beam embedding table associated with a first network entity, wherein the request includes an ID of the first network entity.

Aspect 3 is the method of any of aspects 1 and 2, further includes that the beam embedding table corresponds to the ID of the first network entity.

Aspect 4 is the method of any of aspects 1-3, further includes that the indication to perform the beam prediction procedure is received via RRC signaling or MAC-CE.

Aspect 5 is the method of any of aspects 1-4, further including spatially embedding the past RSRP measurements with the beam embedding of the plurality of BPLs on which RSRP measurements were collected to form the set of input vectors.

Aspect 6 is the method of any of aspects 1-5, further includes that embedding a time index associated with the past RSRP measurements into the set of input vectors.

Aspect 7 is the method of any of aspects 1-6, further including inputting at least the set of input vectors and a plurality of classify tokens into an encoder to generate output vectors used to predict maximum RSRPs for different future time instances.

Aspect 8 is the method of any of aspects 1-7, further includes that each of the plurality of classify tokens is associated with the different future time instances, wherein the output vectors comprise a memory portion and the maximum RSRPs at the different future time instances.

Aspect 9 is the method of any of aspects 1-8, further including inputting the memory portion of the output vectors and the beam embedding of the plurality of BPLs into a decoder to generate a prediction output corresponding to future RSRP measurements of the plurality of BPLs.

Aspect 10 is an apparatus for wireless communication at a UE including at least one processor coupled to a memory and at least one transceiver, the at least one processor configured to implement any of aspects 1-9.

Aspect 11 is an apparatus for wireless communication at a UE including means for implementing any of aspects 1-9.

Aspect 12 is a computer-readable medium storing computer executable code, where the code when executed by a processor causes the processor to implement any of aspects 1-9.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive an indication to perform a beam prediction procedure;
receive a beam embedding table utilized to perform the beam prediction procedure;
measure a reference signal received power (RSRP) for a plurality of beam pair links (BPLs) to generate a set of input vectors for the beam prediction procedure, wherein the set of input vectors is generated based at least on the beam embedding table and past RSRP measurements; and
predict at least one future RSRP measurement of the plurality of BPLs based at least on the set of input vectors and beam embedding of the plurality of BPLs.

2. The apparatus of claim 1, wherein the at least one processor is further configured to:
communicate with a network node based on a prediction of the at least one future RSRP measurement of the plurality of BPLs.

3. The apparatus of claim 1, further comprising at least one transceiver coupled to the at least one processor, wherein the at least one processor is configured to receive the indication to perform the beam prediction procedure and
receive the beam embedding table via the at least one transceiver.

4. The apparatus of claim 1, wherein the at least one processor is configured to:
transmit, to a second network entity, a request for the beam embedding table associated with a first network entity, wherein the request includes an identifier (ID) of the first network entity.

5. The apparatus of claim 4, wherein the beam embedding table corresponds to the ID of the first network entity.

6. The apparatus of claim 1, wherein the indication to perform the beam prediction procedure is received via radio resource control (RRC) signaling or medium access control-control element (MAC-CE).

7. The apparatus of claim 1, wherein the at least one processor is configured to:
spatially embed the past RSRP measurements with the beam embedding of the plurality of BPLs on which RSRP measurements were collected to form the set of input vectors.

8. The apparatus of claim 6, wherein the at least one processor is configured to:
embed a time index associated with the past RSRP measurements into the set of input vectors.

9. The apparatus of claim 8, wherein to predict the at least one future RSRP measurement of the plurality of BPLs the at least one processor is configured to:
input at least the set of input vectors and a plurality of classify tokens into an encoder to generate output vectors used to predict maximum RSRPs for different future time instances.

10. The apparatus of claim 9, wherein each of the plurality of classify tokens is associated with the different future time instances, wherein the output vectors comprise a memory portion and the maximum RSRPs at the different future time instances.

11. The apparatus of claim 10, wherein the at least one processor is configured to:
input the memory portion of the output vectors and the beam embedding of the plurality of BPLs into a decoder to generate a prediction output corresponding to the at least one future RSRP measurement of the plurality of BPLs.

12. A method of wireless communication at a user equipment (UE), comprising:
receiving an indication to perform a beam prediction procedure;
receiving a beam embedding table utilized to perform the beam prediction procedure;
measuring a reference signal received power (RSRP) for a plurality of beam pair links (BPLs) to generate a set of input vectors for the beam prediction procedure, wherein the set of input vectors is generated based at least on the beam embedding table and past RSRP measurements; and
predicting at least one future RSRP measurement of the plurality of BPLs based at least on the set of input vectors and beam embedding of the plurality of BPLs.

13. The method of claim 12, further comprising:
transmitting, to a second network entity, a request for the beam embedding table associated with a first network entity, wherein the request includes an identifier (ID) of the first network entity, wherein the beam embedding table corresponds to the ID of the first network entity.

14. The method of claim 12, wherein the indication to perform the beam prediction procedure is received via radio resource control (RRC) signaling or medium access control-control element (MAC-CE).

15. The method of claim 12, further comprising:
spatially embedding the past RSRP measurements with the beam embedding of the plurality of BPLs on which RSRP measurements were collected to form the set of input vectors.

16. The method of claim 15, further comprising:
embedding a time index associated with the past RSRP measurements into the set of input vectors.

17. The method of claim 16, wherein to predict the at least one future RSRP measurement of the plurality of BPLs, further comprising:
inputting at least the set of input vectors and a plurality of classify tokens into an encoder to generate output vectors used to predict maximum RSRPs for different future time instances.

18. The method of claim 17, wherein each of the plurality of classify tokens is associated with the different future time instances, wherein the output vectors comprise a memory portion and the maximum RSRPs at the different future time instances.

19. The method of claim 18, further comprising:
inputting the memory portion of the output vectors and the beam embedding of the plurality of BPLs into a decoder to generate a prediction output corresponding to the at least one future RSRP measurement of the plurality of BPLs.

20. A computer-readable medium storing computer executable code at a user equipment (UE), the code when executed by at least one processor causes the at least one processor to:
receive an indication to perform a beam prediction procedure;
receive a beam embedding table utilized to perform the beam prediction procedure;
measure a reference signal received power (RSRP) for a plurality of beam pair links (BPLs) to generate a set of input vectors for the beam prediction procedure, wherein the set of input vectors is generated based at least on the beam embedding table and past RSRP measurements; and
predict at least one future RSRP measurement of the plurality of BPLs based at least on the set of input vectors and beam embedding of the plurality of BPLs.
